(19) United States
(12) Patent Application Publication
(10) Pub. No.: US 2016/0351065 A1
(43) Pub. Date: Dec. 1, 2016

(54) SYSTEM FOR PRESENTING A QUESTION PRIOR TO ALLOWING ACCESS TO A VIDEO GAME

(71) Applicants: Thomas J. Sinnickson, Sands Point, NY (US); Steve Edwards, Alexandria, VA (US); Bediako George, Washington, DC (US)

(72) Inventors: Thomas J. Sinnickson, Sands Point, NY (US); Steve Edwards, Alexandria, VA (US); Bediako George, Washington, DC (US)

(21) Appl. No.: 15/168,561

(22) Filed: May 31, 2016

Related U.S. Application Data
(60) Provisional application No. 62/168,065, filed on May 29, 2015.

(51) Int. Cl. G09B 7/00; A63F 13/80; A63F 13/70

(52) U.S. Cl. CPC G09B 7/00; A63F 13/70; A63F 13/80

(57) ABSTRACT

A system for providing access to a gaming software is provided. The present invention includes a computer having a processor and a memory. The processor receives an initiation command from a first user to initiate the gaming software loaded on the memory, launches a gateway software loaded on the memory, produces at least a first learning set and questions for the first user to answer and determine if the entered answers to the questions match a preset answers saved on the memory. The gaming software is initiated if the answers match the preset answers. Alternatively, the gaming software is not initiated if the answers do not match the preset answers and at least one new learning set and questions are produced for the first user to try again.

### CROSS-REFERENCE TO RELATED APPLICATION

This application claims the benefit of priority of U.S. provisional application No. 62/168,065, filed May 29, 2015, the contents of which are herein incorporated by reference.

### BACKGROUND OF THE INVENTION

The present invention relates to video games and, more particularly, to a system that requires a user to learn something first by presentment of a learning set followed by questions that must be answered correctly prior to allowing access to a video game.

Both adults and children play games, watch videos, listen to music, or otherwise use electronic entertainment devices for pleasure. Much of this time spent with entertainment devices does not result in an increase in the individual's knowledge.

As can be seen, there is a need for a system that requires a user to review a learning set followed by questions that must be answered correctly (learn something) prior to allowing access to a video game. The learning set can consist of written, audio or video content or material.

### SUMMARY OF THE INVENTION

In one aspect of the present invention, a system for providing access to a gaming software comprises: a computer comprising a processor and a memory, wherein the processor receives an initiation command from a first user to initiate the gaming software loaded on the memory; launches a gateway software loaded on the memory; produces at least a first learning set followed by questions that must be answered correctly by the first user; and determines if an entered answers to the questions match a preset answers saved on the memory, wherein the gaming software is initiated if the answers match the preset answers, or the gaming software is not initiated if the answers do not match the preset answers a second learning set and questions are presented and so on.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a flow chart of an embodiment of the present invention; and

FIG. 3 is a continuation of the flow chart of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system that prompts a player of video games to learn something first before starting a game. For example, the player is presented with at least one learning set followed by questions, that relate to the content presented that the player answers prior to playing the video game. Using the adult's or child's desire for pleasure, the individual is now incentivized to learn something first before engaging with an electronic entertainment device. Additionally, the individual learns the valuable lesson of work before pleasure.

The present invention includes a gateway software which behaves as a gateway to other video game software. The present invention may be installed on a gaming platform, video player, audio player, personal computer, smart phone, tablet, handheld gaming device, television, or any other electronic device used for the purpose of entertainment.

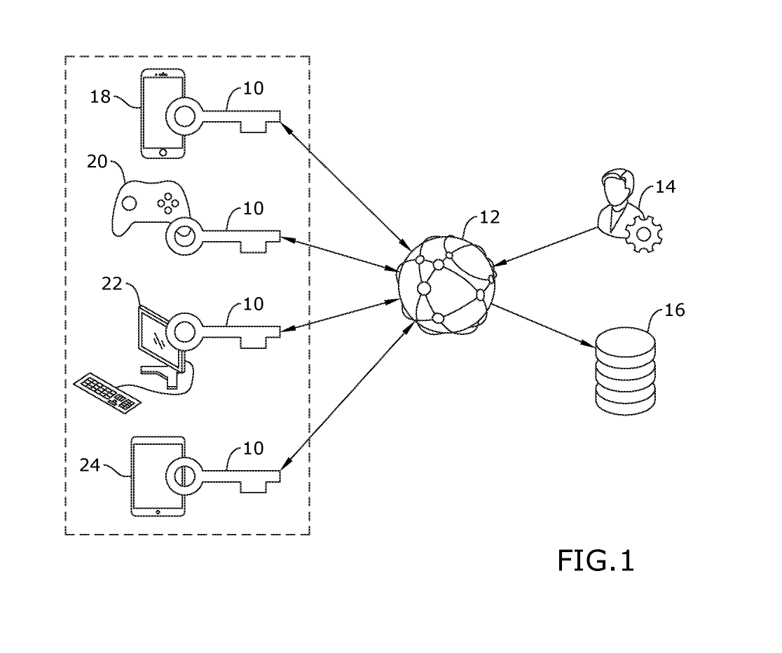

Referring to FIG. 1, the present invention includes a system for providing access to a gaming software. The present invention includes a computer 18, 20, 22, 24 having a processor and a memory. The processor receives an initiation command from a first user to initiate the gaming software loaded on the memory, launches a gateway software loaded on the memory, produces at least a first learning set and questions that must be answered correctly by the first user and determines if an entered answers to the questions match a preset answers saved on the memory. The gaming software is initiated if the answers match the preset answers. Alternatively, the gaming software is not initiated if the answers do not match the preset answer and a second learning set and questions are presented and the user must try again.

The present invention may include multiple modules. A front end module 10 may be the gateway software. The frontend module 10 is installed on the computer 18, 20, 22, 24. The computer 18, 20, 22, 24 may include one of a smart device 18, a gaming console 20, a desktop computer 22, a laptop computer, a tablet 24 or any other electronic device used for the purpose of entertainment.

The present invention may further include a back end module 12. The back end 12 module may include a series electronically and telephonically accessed services (such as web services accessed over the Internet) that provide specific application state to the front end module 10 of the invention. This application state includes but is not limited to, user authentication and authorization information, challenge questions, a record of what questions have been answered, a record of how many questions were answered correctly and incorrectly, as well as a record of what types of questions the user should be challenged with. The back end module 12 may also be responsible for receiving and recording heartbeat and other installation status information from the front end 10. The back end module 12 may be in the form of a server, a cloud or other networked computer installation, or it may be part of the gateway software and installed locally on the computer 18, 20, 22, 24.

The present invention may further include an administrative module 14. The administrative module 14 is accessed by an administrator and can be used to configure the behavior, security, and other aspects of both the front end module 10 and the back end module 12. For instance, the administrative module 14 may allow the administrator to create different user accounts with different login criteria for each user. Further, different questions may be assigned to the different accounts, allowing different users to be presented with varying levels of subject matter. As such, the system may exhibit user personalization characteristics. The administrative module 14 may be in the form of a server, a cloud or other networked computer installation, or it may be part of the gateway software and installed locally on the computer 18, 20, 22, 24.

The present invention may further include a recording module 16. The recording module may be accessed by users via the user accounts and by the administrator. The recording module 16 records statistics, such as, but not limited to, the learning sets answered correctly and incorrectly by the user, the type of questions (for example, the type of subject matter of the questions), the amount of learning sets answered in total and the like. The recording module 16 may be its own database operable to send information to the back end module 12 and the front end module 10. The recording module 16 may also be in the form of a server, a cloud or other networked computer installation, or it may be part of the gateway software and installed locally on the computer 18, 20, 22, 24.

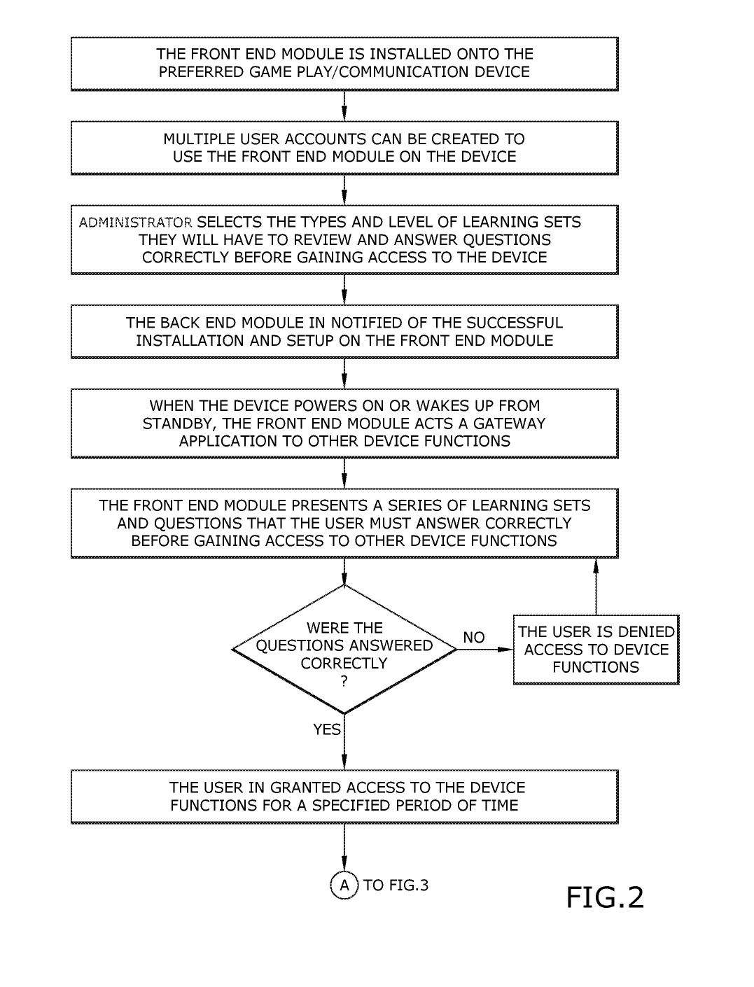

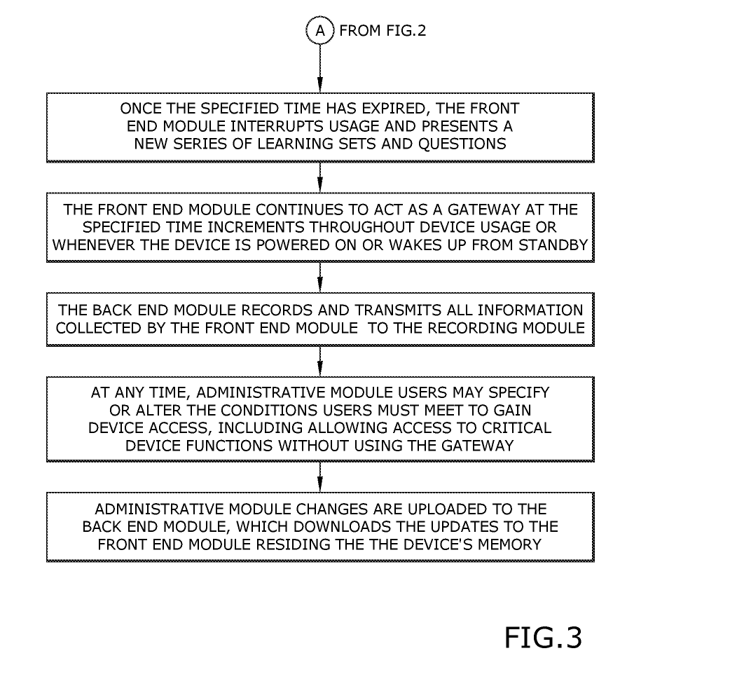

Referring to FIGS. 2 and 3, an administrator may install the front end module 10 on a computer (device), and create multiple user accounts accessible by different users. The administrator may then choose what types of learning sets and what level of are assigned to each user account. The back end module may be notified of the successful installation of the front end module. When the device or computer is powered on or wakes up from standby, or if the gaming software is initiated, the front end module acts as a gateway. The front end module presents at least one learning set and questions that must be answered correctly by the user after the user has signed into the user account. If the questions to the learning set is not answered correctly, the user is denied access to the device function and is presented with a second learning set and questions. If the user answers the questions correctly, the user has access to the device functions for a specified period of time. Once the specified time has expired, the front end module interrupts the useage and presents a new learning set. The front end module continues to act as a gateway at the specified time increments throughout the device usage or whenever the device is powered on or wakes up from standby. The back end module records and transmits all of the information collected by the front end module to the recording module. At any time, the administrative module allows administrators to specify or alter conditions users must meet to gain device access, including allowing access to critical device functions. Administrative module changes are uploaded to the back end module, which downloads the updates to the front end module residing on the device's memory.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for providing access to a gaming software comprising:
a computer comprising a processor and a memory, wherein the processor
receives an initiation command from a first user to initiate the gaming software loaded on the memory;
launches a gateway software loaded on the memory;
produces at least a first learning set and questions for the first user to answer; and
determines if an entered answers to the questions match the preset answers saved on the memory, wherein
the gaming software is initiated if the answer matches the preset answers, or
the gaming software is not initiated if the answers do not match the preset answers and at least one new learning set and questions are produced.

2. The system of claim 1, wherein the processor
receives data from an administrator, wherein the data comprises information about a plurality of users forming a plurality of user accounts; and
prompts the administrator to link at least one question to each of the user accounts.

3. The system of claim 2, wherein the processor
prompts the first user to sign into one of the user accounts after the gateway software has been launched and prior to producing the first question; and
produces the at least one learning set and questions linked to the user account that the user has signed into.

4. The system of claim 3, wherein the entered answer is stored to the respective user account.

5. The system of claim 4, wherein the processor
records an amount of questions answered correctly and an amount of questions answered incorrectly.

6. The system of claim 1, wherein the computer comprises one of a smart device, a gaming console, a desktop computer, a laptop computer and a tablet.
